(19) United States
(12) Patent Application Publication
(10) Pub. No.: US 2003/0018563 A1
(43) Pub. Date: Jan. 23, 2003

(54) Trading and processing of commercial accounts receivable

(75) Inventors: Colin Lawrence Kilgour, Toronto (CA); Andrew Kevin Dayes, Toronto (CA)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Efficient Capital Corporation, Toronto (CA)

(21) Appl. No.: 09/904,986

(22) Filed: Jul. 13, 2001

(51) Int. Cl. G06F 17/60

(52) U.S. Cl. 705/37; 705/36; 705/30

(57) ABSTRACT

The present invention is a system and method combining financial product innovation, business process management, and proprietary software integration in a holistic fashion for the funding, trading, processing and management of commercial accounts receivable.

The invention opens up a new asset class for dynamically traded investment on an exchange for primary, secondary, and distress markets.

On the ‘sell’ side of the exchange, merchants will offer their daily receivables. On the ‘buy’ side, investors, typically of an institutional nature, will be able to bid on lots of accounts receivable, which will be combined with credit enhancement features in order to mitigate the risk of investment. The present invention promotes liquidity and pricing efficiency by facilitating an end-to-end dynamic trading process. In addition, the exchange operator will also serve as a business process outsourcer, managing the accounts receivable process for the assets that trade through its exchange.

### FIELD OF THE INVENTION

This invention relates to a method and system for facilitating financial investment in the trading and processing of commercial accounts receivable (“AR”).

### BRIEF DESCRIPTION OF THE DRAWINGS

Embodiments of the invention will be described by way of example and with reference to the drawings in which:

FIG. 1 is a diagram indicating the yields of various investment vehicles versus term.

FIG. 2 is a diagram of the drivers of the invention market opportunity.

FIG. 3 illustrates the parties' relationships with the AA and ARMMS.

FIG. 4 shows a high level diagram of a preferred embodiment of the invention process.

FIG. 5 is a flow chart of payments and title to AR.

FIG. 6 shows the workflow of the accounts receivable outsourcing process.

FIG. 7 illustrates the invention application in a preferred embodiment.

### BACKGROUND OF THE INVENTION

Typically, commercial transactions between businesses involve the seller of a good or service (“merchant”) delivering the good or service to the purchaser (“buyer”) in advance of receiving payment. From the time that the good/service is delivered until such time as the buyer pays for it, the merchant is said to have an account receivable with the buyer. The AR is a financial asset that indicates the expectation of future payment according to the terms of the commercial relationship between the merchant and buyer. In many industries, a merchant generates AR by extending credit on virtually all of its sales. Therefore, the timely and complete payment of AR is critical to the cash flow of any merchant: left unpaid, AR will ultimately leave the merchant without the necessary cash to meet its own financial obligations.

Commercial AR is one of the largest classes of financial assets in developed economies. The estimate of the outstanding amount of commercial AR in the United States in 2001 is over $7.3 trillion dollars with a total annual volume of $59.4 trillion.

Despite their immense size, commercial AR are generally illiquid, inefficiently funded and, when traded, are inefficiently priced. There are presently only a limited number of ways to fund AR: using the merchant's internal capital; borrowing from a bank or other financial institution by pledging the AR as collateral; factoring; assignment to collection; issuing commercial paper; and securitizing the merchant's AR:

Internal Capital—Funding AR via a merchant's internal capital is inefficient since it uses the merchant's long-term capital to meet a short-term, lower-risk funding requirement. This represents a mismatch in terms of the maturity profile of the corresponding assets and liability, and also a risk mismatch. From a risk perspective, AR represents a contractual obligation from the buyer to a merchant and would generally be considered to be a lower risk compared to all the other business and financial risks a company faces in its daily operations. Accordingly, the AR ought to be funded using a lower risk premium than what is reflected by a merchant's overall risk profile.

Borrowing—Obtaining operational financing via loans from a bank or other financial institution using AR as assigned collateral often entails the merchant's endurance of restrictive covenants upon its business and financial management practices, which may restrict its ability to operate efficiently. Banks typically charge high rates of interest for these types of loans since they perceive the risk of non-payment to be somewhat higher than empirical experience would suggest. In addition, in an effort to diversify its risk, a single bank will very likely not fund a merchant's entire AR book, making additional funding arrangements necessary.

Factoring—Factoring is an arrangement between a financing company (the factor) and a merchant whereby the factor purchases the merchant's AR at a discount and assumes responsibility for the merchant's customers' (hereinafter buyers) financial ability to pay. If a buyer is financially unable to pay its debts, the factor incurs the responsibility for payment. The factor assumes responsibility for the credit extended to the merchant's customers, collects the AR from those customers, and performs the related bookkeeping functions. The constituency of factors has traditionally been companies with a restricted cash flow situation, or those with distressed assets; not healthy growing companies seeking alternative funding for their outstanding AR. This being the case, factors typically charge a steep discount and demand a minimum annual fee for their services. In addition to the discount charged for their services, factors typically also hold back a relatively large portion of the notional amount of the AR until the client has paid, in order to protect against the risk that the client will not pay, or pays late. As well, factors typically demand that a client retain their services for a fixed amount of time. These service contracts are generally only cancellable upon a certain period of notice.

Assignment to Collection—When a merchant that has extended AR to a buyer is unable to collect on it, the merchant can sell the AR to a collection agency at a discount to its face value. The title then transfers to the collection agency, which makes its profit on the difference between the amount it paid for the AR and the amount it is ultimately able to collect from the buyer.

Commercial Paper—Large corporations often issue short-term fixed income instruments, collectively known as commercial paper, to fund their short-term operations, which typically include funding AR. Because the fees charged by investment banks to arrange such issues are relatively high, smaller firms are unable to access capital markets in this manner, and it is only economic for larger merchants to do so.

Securitization—Large corporations that extend AR to their clients—usually credit card receipts for retail operations and AR for wholesale operations—often turn these loans into marketable securities through a process known as securitization. These corporations sell pools of AR to another corporation known as a special-purpose vehicle (“SPV”), whose sole function is to buy such assets in order to securitize them. The SPV then sells them to a trust. The trust repackages the loans as interest-bearing securities and actually issues them. The sale of the loans by the sponsor to the SPV provides “bankruptcy remoteness”, thereby insulating the trust from the sponsor. Units in the newly created securities are then sold to investors by the investment banks that underwrite them. As in the commercial paper market, the fees inherent in the securitization process render this means of accessing capital markets inefficient for all but large commercial entities.

In sum, cost effective AR funding and, particularly, access to the liquidity of public capital markets, are usually available for larger organizations but not smaller and medium sized businesses. Table 1, below, provides a summary of the relative cost of each of these funding methods in increasing order of efficiency:

TABLE 1
Summary of AR Funding Methods

| Funding | | |
|---|---|---|
| Method | Relative Cost | Comment |
| Collection | Highest | Typically employed only when |
| | | likelihood of full payment is very low |
| | | Liquidity and pricing efficiency are |
| | | reduced by one-to-one transactions |
| Factoring | Very High | Typically associated with, and utilized |
| | | by, either distressed receivables or |
| | | organizations facing a cash flow crisis |
| | | The factor generally must hold on to |
| | | the asset until payment is received |
| | | Liquidity and pricing efficiency are |
| | | reduced by one-to-one transactions |
| Internal Capital | High | Most common funding technique |
| | | among medium sized organizations |
| | | AR funded at Weighted Average of |
| | | Capital (“WACC”) |
| | | WACC does not reflect the term |
| | | structure and default risk of normal |
| | | receivables |
| Bank Loan | Medium - High | Common funding technique |
| (General | | High cost |
| assignment of | | Subject to possible restrictive |
| AR) | | covenants |
| | | Banks will typically not fund the entire |
| | | AR portfolio |
| | | Liquidity and pricing efficiency are |
| | | reduced by one-to-one transactions |
| Commercial | Least | Effective funding technique for large |
| Paper | | enterprises |
| | | Not available to medium sized |
| | | organizations |
| | | Initial pricing process is static rather |
| | | than dynamic, reducing pricing |
| | | efficiency |
| Securitization | Least | Effective funding technique for large |
| | | enterprises |
| | | Typically only available to large |
| | | retailers or credit card issuers |
| | | Not available to medium sized |
| | | organizations |
| | | Purchase of the security and not the |
| | | underlying asset |
| | | Initial pricing process is static rather |
| | | than dynamic, reducing pricing |
| | | efficiency |

Beyond the high cost of funding AR, processing them (e.g. record keeping, administration and collection) generally consumes an inordinate level of management and staff resources for medium-sized commercial enterprises. Furthermore, the pursuit of a small number of delinquent accounts often demands a significant and disproportionate level of senior management attention. Therefore, outsourcing the AR management process can be very attractive for many merchants.

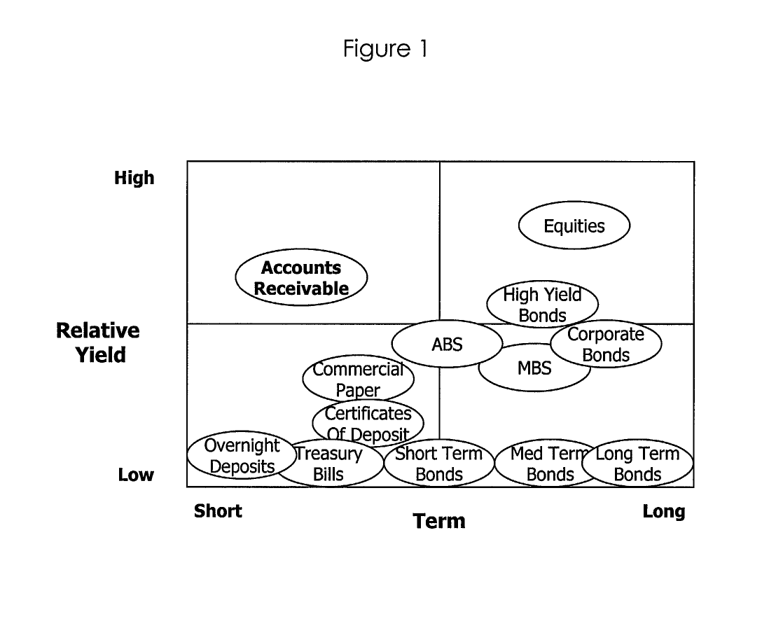

From an institutional investor's perspective, there is an increasing scarcity of relatively high-yielding, short-term investment vehicles. For example, in Canada the availability of money market investment opportunities has significantly decreased during the past decade. When compared to other forms of popular investment vehicles across the yield curve such as equities, high-yield bonds, corporate bonds, asset-backed securities, mortgage-backed securities, commercial paper, certificates of deposit, bonds of long, medium and short term issued by various levels of government, treasury bills, and overnight deposits, only equities have a potentially higher yield and overnight deposits a shorter term than AR as a form of investment. In sum, if there existed an opportunity to efficiently access the AR market via a dynamic trading mechanism, AR would represent to institutional investors a uniquely attractive asset class for investors given its combination of risk and term to maturity. FIG. 1 provides an illustration of AR's relative status with regard to potential yield and term in comparison to these other classes of investment.

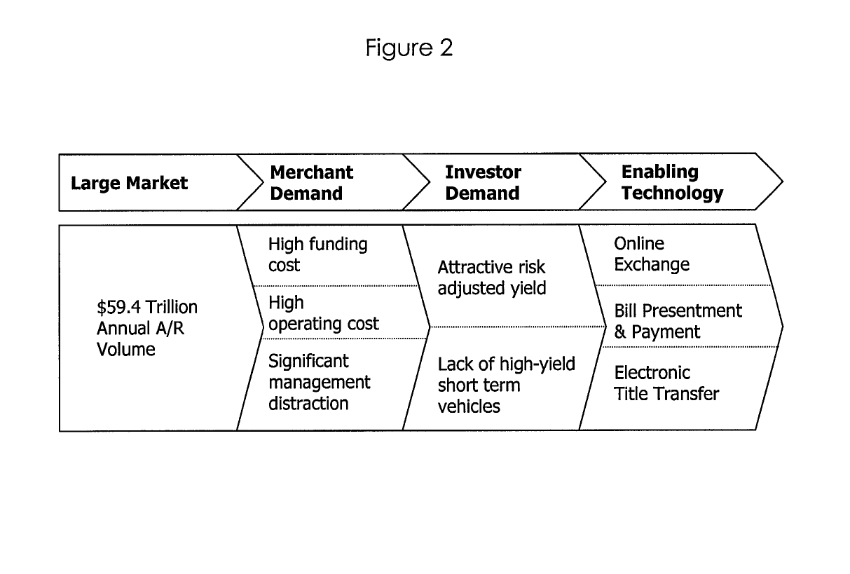

However, despite the size of the asset class as a whole, the means for institutional investors to actively trade AR through a large-scale Exchange mechanism does not currently exist. Compounding this is the fact that there is no developed secondary market for these assets. Institutional investors require the ability to dispose of assets as they wish by selling them on to other investors. Another factor limiting the development of a liquid institutional AR market has been the statutory inability of many large mutual, insurance and pension funds to invest in assets that do not posses an investment grade credit rating. AR originated by smaller and medium sized merchants would typically not carry such a rating. FIG. 2 provides an overview of the commercial drivers behind the present invention.

### SUMMARY OF THE INVENTION

According to one embodiment, the present invention includes a method for facilitating a financial investment in at least one accounts receivable owned by a first person, comprising the steps performed by a systems manager using a computer-based system of: enrolling the at least one accounts receivable owned by the first person as a lot for a trade using a computer database; receiving at least one bid from at least one bidder for purchasing the lot; and determining the result of the trade for the lot; wherein each account receivable of the at least one accounts receivable is associated with a merchant's buyer and a merchant. In a variation, the merchant enhances the credit quality of the lot of accounts receivable to investment grade.

According to another embodiment, this invention further includes a system for facilitating a financial investment in at least one accounts receivable owned by a first person, operated by a systems manager, comprising electronic processors and electronic input-output devices which are adapted to communicate information using language, icons and graphical images, a computer database, and a communication network, wherein the at least one accounts receivable owned by the first person is enrolled as a lot for the trade in the computer database; at least one bid from at least one bidder is received for purchasing the lot; and, the result of the trade for the lot is determined; wherein each account receivable of the at least one accounts receivable is associated with a merchant's buyer and a merchant.

According to a further embodiment of this invention there is provided a financial instrument for financial investment using a computer-based system comprising at least one accounts receivable owned by a first person, each account receivable of the at least one accounts receivable being associated with a merchant's buyer and a merchant, wherein a systems manager using the computer-based system:

(a) enrolls the at least one accounts receivable owned by the first person as a lot for the trade in a computer database;

(b) receives at least one bid from at least one bidder for purchasing the lot;

(c) determines the result of the trade for the lot; and

the merchant enhances the credit quality of each of the at least one accounts receivable for bringing the credit quality of the at least one accounts receivable up to investment grade.

### OBJECTS OF THE INVENTION

The present invention combines financial product innovation, business process management, and proprietary software integration in a holistic fashion for the funding, trading, and processing of commercial accounts receivable.

The invention opens up a new asset class for dynamically traded investment; commercial accounts receivable are typically by far the largest asset class in developed countries where business is transacted on terms of trade, yet they are generally illiquid. The invention creates liquidity in this market.

The invention's holistic process is novel for a number of reasons:

It provides a dynamic marketplace for the trading of commercial accounts receivable;

The dynamic trading process enables the marketplace to discover the appropriate discount to be applied to accounts receivables, as opposed to lending, factoring, issuance of commercial paper or securitization, where yields are determined by self-interested parties;

It facilitates a many merchants to many investors trading relationship whereas factoring and collection tend to employ one to one relationships and securitization and the issuance of commercial paper tend to employ one to many relationships. The pluralities of relationships fostered by the invention promote hitherto unknown liquidity and efficiency of pricing in the funding of accounts receivable, particularly in the primary market;

It provides a secondary market for accounts receivable trading. In current funding methods, the asset purchaser must hold typically hold the asset until payment is received. In this model, the same asset can be traded multiple times prior to receipt of payment;

It facilitates both account receivable processing and financial trading of the asset. Concurrently, it disintermediates the processing aspect so that merchants need not perform the receivables function, yet investors need not assume collection responsibilities. In other models, the merchant either retains responsibility for collection or the investor assumes it when the asset trades hands; and,

It uses optional credit enhancement to guarantee a portion of the value of the assets traded, thus reducing the need for investors to conduct rigorous due diligence of the asset quality.

Characteristics of Utility Specific to Investors' Interests

The present invention:

Creates a new vehicle for short-term investors to trade; availability of money market investment opportunities has significantly decreased in Canada during the past decade (source: Bank of Canada Review, Summer 1998);

Offers money market investors potentially, and very likely, higher yields than vehicles of a similar term structure; and,

Offers this potentially higher yield with a third party credit enhancement to decrease risk of default. The risk of the merchant's client default on payment is a prime concern to investors who may buy the accounts receivable. The application of credit enhancement provides a cost-efficient solution that reduces the concern of default. In essence, the innovative use of credit enhancement in the present invention allows for increased short-term yields with the existence of a significantly improved credit rating.

Characteristics of Utility Specific to Merchants' Interests

The present invention:

Allows merchants to accelerate their cashflow by discounting their invoices;

Allows merchants to more accurately predict cashflows, since merchants' exposure to bad debt is eliminated or significantly reduced;

Allows merchants to access alternate sources of capital, presumably at a lower cost of capital than existing methods;

Allows merchants to realize significant reductions in operational costs and management distraction by outsourcing their accounts receivable department;

Allows merchants to selectively sell their accounts receivable by a dynamic trading process; since reserve prices will be accepted, there is no requirement to automatically accept lowest bid; and,

Allows merchants to improve their overall return on equity without necessitating any marked change in their overall market or operational performance (i.e. deriving similar earnings with a lower equity base yields an increased return on equity)

While there is presently some commercial activity around accounts receivable, it is generally oriented at retailers (credit card receivables), large corporations (securitization or commercial paper), or delinquent accounts (factoring, collection). Apart from the practice of assigning AR as collateral against bank loans, there is virtually no commercial funding available for receivables generated by healthy, mid-sized companies.

Further to the above, while there presently exist securitized pools of assets in which units are sold (Asset Backed Securities and Mortgage Backed Securities), the present invention, for the first time, affords the general investment community the opportunity to acquire the underlying assets directly through a dynamic trading process.

In providing the investment community with the opportunity to acquire these assets, the present invention concurrently provides merchants with working capital funding options that do not presently exist.

Sophisticated electronic software has become available and acceptable for commercial purposes only within the last few years. The operation and administration of the AA's various business functions—encompassing the dynamic trading Exchange, electronic title transfer, accounts receivable management, electronic payment and workflow and resource management—are facilitated by readily available commercial software. This invention allows better ways to facilitate financial investment in accounts receivable. No other method or system provides the advantages of the invention.

### DETAILED DESCRIPTION OF THE INVENTION

This invention concerns methods and systems for trading and managing accounts receivable as a financial instrument. Although this primarily concerns commercial AR as reflected in the following description, it is not limited to such, which would be apparent to a person skilled in the art.

Overview

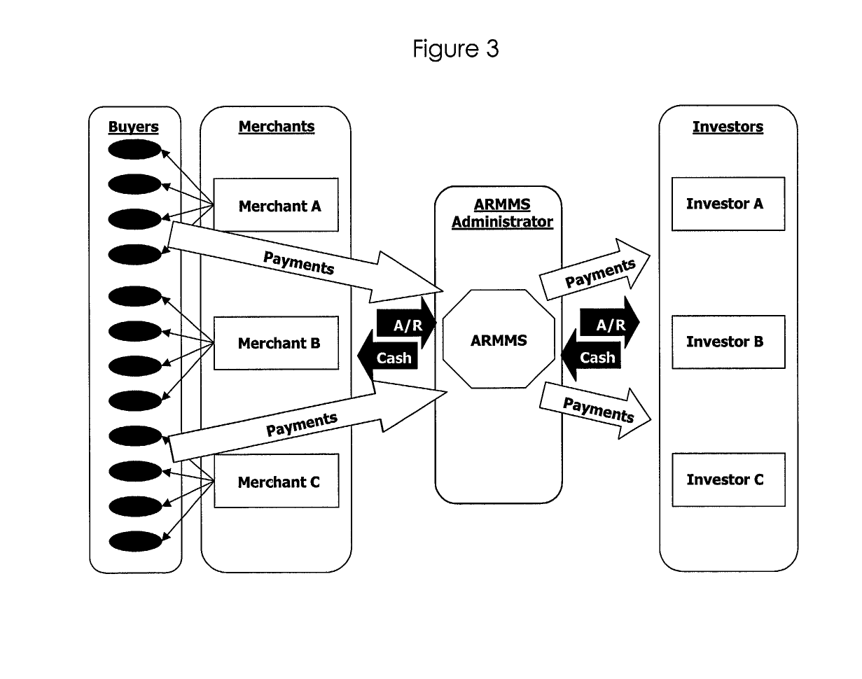

FIG. 3 illustrates an overview of a preferred embodiment of the invention indicating the four main classes of participants in the overall process and how they apply the invention in interacting with each other for the purpose of trading and managing AR.

An Accounts Receivable Market and Management System (“ARMMS”) is a holistic computer system that provides automation to enable the dynamic trading and processing of AR, including the use of computer hardware and system software. A central sub-system (the “Exchange”), acts to integrate a number of otherwise autonomous and independent operations/applications for trading of AR. The Exchange also allows, in a preferred embodiment, for the secondary trading of AR subsequent to their initial sale, with the attendant transfers of title and re-direction of payments. An ARMMS administrator (“M”), also known as a systems manager, provides the necessary oversight and control to ensure that the ARMMS and Exchange function appropriately.

Merchants will offer their AR for sale on the Exchange and these AR will subsequently be available for investors to purchase and for the AA to collect payment thereof. By selling title to the AR for cash through the Exchange, merchants need not exhaust their capital sources to fund them, thus freeing up existing equity and debt capital for alternate strategic initiatives. Further, merchants will be relieved of the obligation to collect and otherwise manage their AR.

Investors individually purchase and sell these AR as investments in a primary market for such AR. The AA, interposed between the merchants and the investors, administers the market.

Another aspect of this invention involves the provision of a secondary market enabling AR to be traded by investors as an investment. After it has been traded initially from a merchant to an investor, an AR lot (comprising of at least one AR) may be traded multiple times amongst investors prior to ultimate receipt of payment from the buyer.

The dynamic trading process facilitated within ARMMS enables the marketplace to discover a true and appropriate discount to be applied to AR, as opposed to factoring, bank loans, securitization, or the issuance of commercial paper where self-interested parties determine yields. It also facilitates liquidity via a many-merchants to many-investors trading relationship whereas factoring and collection tend to employ one to one relationships and securitization and commercial paper issuance tend to employ one to many relationships.

According to another aspect of this invention, the AA employs the Exchange to administer all the AR traded. This includes, among other activities, tracking, reporting upon, collecting the outstanding AR, and forwarding the proceeds to the owner of the AR. This however does not extend to the role played by a collection agent for delinquent accounts.

ARMMS also provides for an optional distressed AR (i.e. seriously delinquent) market where such AR may be sold via a trading system to collection agencies or other entities willing to take the risk of non-payment in return for the possibility of enhanced yield.

The Parties

The principal parties to the Exchange are collectively referred to as members of the Exchange. For the most part, parties will choose to become members and will undergo a reasonable series of validation checks to ensure that their membership is appropriate and accurately represented to other members. The principal types of Exchange members are:

Merchants;

Buyers;

Investors;

The ARMMS Administrator;

Collection Agents; and,

Credit Insurers.

Each of their respective roles is outlined in the following paragraphs.

Merchants and Buyers—The ARMMS is primarily concerned with the trading and processing of existing AR related to prior transactions between buyers and merchants. These transactions may arise out goods sold, services rendered, or any other commercial dealings such as those in the intellectual property, real estate or securities fields that result in an AR. These buyers and merchants may be physically located in the same general geographical location or in widely distributed areas, including different countries. The transactions may have occurred by any commercially accepted means in any currency, whether completed or not.

Merchants who become members of the Exchange will be able to trade their AR through it and will have their AR processed by the AA. Buyers who are customers of a member merchant will become de facto members in that their payments will flow through the Exchange and they may interact with the AA with regard to specific items related to AR management and collection.

Prior to being offered for sale on the Exchange, AR will be arranged into lots, each lot being assigned a unique serial number to aid in tracking transfer of title and payment. These lots may comprise one or more separate transactions resulting in an AR. In one preferred embodiment, AR originating from a single merchant but comprising transactions to one or more buyers, each transaction possessing the same due date of payment, would be offered as a specific lot on the Exchange.

Investors—Investors are those persons or organizations that will be the primary purchasers of AR traded through the Exchange. They will register as members of the Exchange and, once they are qualified as bona fide investors and have completed the investor enrolment process, they will be able to access AR offered for sale and will be able to submit bids to purchase them. Additionally, they will be able to access the Exchange to resell AR they have previously purchased through the Exchange. This will allow them to enter and exit financial positions without necessarily awaiting ultimate payment from the original buyer.

In one preferred embodiment, Investors will typically be characterized as Institutional Investors—insurance companies, mutual funds, investment managers, and, pension funds. However, it is possible for virtually any entity, in any geographic region, with investable assets to be positioned as an investor for the purposes of this invention.

ARMMS Administrator—The AA has overall responsibility for all administrative tasks in relation to the ARMMS. In a preferred embodiment, since the transactions are generally electronic in nature, the AA operates and manages an online computer system to facilitate the transactions, i.e. the Exchange. This system and the associated computer programs are discussed in more detail later in this document. Because efficiencies of labor and data processing have been made possible by the advent of electronic hardware and software, the likely embodiment of the invention will involve the use of a computer system to facilitate transactions. However, it would be possible, though economically unfeasible, to effect the invention by purely manual means, as would be apparent to one skilled in the art.

The AA further performs other administrative functions to effect and finalize the AR trading transactions, typically using the ARMMS. Such functions would include but be not limited to the registration of Exchange members, recording information related to specific AR, effecting transfer of tangibles or funds between the parties, and preparing statements and other documentation for reporting, accounting or regulatory purposes.

According to another aspect of this invention, the AA administers the AR on behalf of the merchants and investors, collecting from the buyers and forwarding funds received to the owners of the AR, whether the current owner is the originating merchant or an investor. This aspect is intrinsic to the operation of the secondary market described above. Since the merchant originating the AR will have relinquished legal title of the AR to an investor in the primary market in return for payment, that merchant cannot reasonably be expected to be responsible for further administration and collection of payment from the buyer on behalf of the investor. Indeed, such an arrangement would invite the possibility of moral hazard between an originating merchant and/or a buyer and/or an investor. Therefore, in order to maintain an efficient and impartial transfer of title and administration of payment between the selling investor and the subsequent buyer of the AR lot re-sold on the secondary market, the AA will maintain control of the administration of all AR transacted through the Exchange from origination until the AR final payment.

Collection Agents—Another class of parties playing a subsidiary role is that of collection agents. In a preferred embodiment, where delinquent accounts arise on account of the buyer's failure to pay the AR time according to the credit terms mutually agreed by the originating merchant and the buyer at the time of sale), upon: a) the AA's verification of buyer-specific conditions received from the originating merchant; and, b) upon direction from the current owner of record of the legal title to the AR, the distressed assets may be dynamically traded to collection agents or other qualified parties willing to accept the possibility of enhanced yield as a quid pro quo of the increased likelihood of ultimate default, which will be reflected in the very likely increased discount offered for these distressed assets. Assets sold through the distressed AR embodiment may be entire lots of AR as originally structured, a portion of which exhibits characteristics of untimely payment, or those lots may be broken up and individual AR sold on a piecemeal basis. As with all transactions conducted through the Exchange, the AA will effect transfer of title to the AR and administer reciprocal payment for such. However, for distressed AR disposed through the Exchange in the above manner, the AA will relinquish control of the administration and collection of such assets. The collection agent or other qualified party will therefore bear sole responsibility for ultimately collecting payment of the AR.

Credit Enhancement Facilitators—Entities providing forms of credit enhancement, such as credit insurance companies, form a possible further class of parties. One preferred aspect of this invention is a requirement that any AR entering into the ARMMS be insured (although not being mandatory in nature). Therefore, if a buyer fails to pay any or part of an AR because of insolvency or refusal to pay, any shortfalls are covered by, for example, insurance, underwritten by credit insurers. The use of credit enhancement is described in more detail later in this document.

The Overall Process

The present invention deals with the scenarios discussed above by combining financial product innovation, business process management, and proprietary software in a holistic fashion which facilitates the introduction of liquidity and efficient pricing into the process of funding, trading, and processing of commercial accounts receivable.

All participants in the ARMMS process would be required to register with the ARMMS, preferably using the Exchange under some agreement setting out the mutual obligations of the parties. In addition to typical provisions in a contract and those related to matters specifically referred to in this document, the agreement may include those governing:

disclosure requirements by the new member;

insurance-related requirements;

collection of the AR;

advances of funds or other such funding options;

possible arrangements with investors and/or buyers; and,

banking end payment instructions.

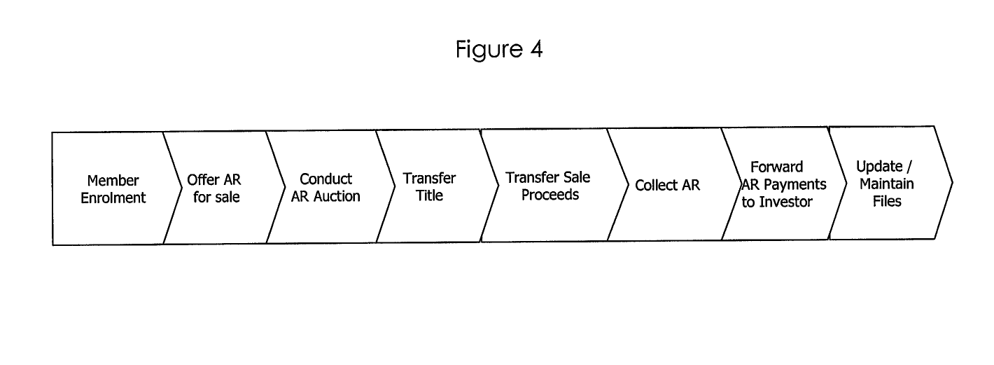

The typical way that the process of this invention would work is as shown in FIG. 4. A merchant, having an AR (or a portfolio thereof) in respect of a particular commercial customer or due date would approach an M, which operates an ARMMS as mentioned above, and initiate this process, as follows:

Member Enrolment is the process whereby new participants in the Exchange are registered and their profiles are created, validated, and made available to other members as appropriate. There are distinct enrolment sub-processes for each class of Exchange member—merchants, investors, credit insurers, or collection agents.

Offer AR for Sale is the process where a member merchant may submit a package of accounts receivable (“a lot”) for purchase. This process involves receiving the lot, conducting appropriate validation, and then preparing suitable parameters for an online trade of the lot. The AA offers the AR to investors for sale in a primary market. Potential investors may be notified actively by email, telephone, facsimile, or some other electronic means of certain details of the AR. The investors notified may be selected based on certain criteria, which may include the characteristics of the AR, or the merchant's identity or characteristics. Alternatively, the notification process may be passive whereby investors may inspect electronic repositories of the Exchange of available AR with associated information, which are for sale at the investors' own leisure. These repositories may be divided into different categories that the potential investors can traverse using a directory, or the repositories may be implemented using database methodology and inspection by the potential investors achieved via database queries. For the purpose of confidentiality, the merchant typically posts the AR data but not the underlying data identifying the buyers. In its turn, the AA typically requires individual invoice data, but access to both the invoice data and the buyer data is denied to the investor.

Dynamic Trading, in one preferred embodiment of the invention, is the process of staging an electronic dynamic sale of AR lots wherein the act of potential investors bidding on those lots facilitates real-time price discovery. This process makes the lots available to bidders and also provides information on the specific parameters of the sale as well as relevant information on the seller and the lot itself. While there are many alternative embodiments of dynamic trading systems and environments, which would be apparent to one skilled in the art, for the purposes of this document, the term “trading system” will be used hereinafter to indicate any of such possible dynamic trading processes. Outlined below are several embodiments of dynamic trading systems used for trading financial instruments.

Auction Systems—Auction systems enable participants to conduct electronic auctions of financial instruments. Some auction systems are tailored to new issues in the primary market. Others focus on auctions of secondary market offerings by investors or others. In either case, a merchant, through an AA, would typically post the details of a lot of AR being offered for sale and the specific terms of the auction, i.e., whether the auction is single-price or multiple-price, the time the auction is open, whether partial orders will be filled, etc. Investors would be able to submit bids for the offered lots and the offering would be awarded to the bidder that offers the highest price or lowest discount. In some cases, the identities of the investors and the amounts of the bids would be kept anonymous. In others, identities and/or bid amounts would be viewable by all participants.

There are diverse manifestations of the auction process, among the more common: forward auctions, in which multiple buyers bid on one seller's lots; reverse auctions, wherein one investor bids on multiple sellers' lots; and, Dutch auctions, in which the AA would examine all bids for a number of a merchants' lots and determine the lowest acceptable bid price above the reserve placed by the merchant. All successful bidders would pay this price.

Cross-Matching Systems—Cross-matching systems would generally bring both merchants and investors together in electronic trading networks that provide real-time or periodic cross-matching sessions. Investors would be able to enter anonymous buy and sell orders with multiple counterparties (either merchants in primary markets, or other investors in secondary markets) that would be automatically executed when contra side orders were entered at the same price or when the posted prices are “hit,” (i.e. the investor had matched the seller's pre-determined reserve price) or “lifted.” (i.e. the seller had decided to accept a lower price by removing or lowering the reserve price).

Anonymous Trading Systems—Anonymous trading systems would allow investors to execute transactions electronically with others through the fully anonymous services of an AA acting as a “brokers' broker”. In other asset classes, a number of brokers have introduced electronic transaction systems that allow institutional investors to execute transactions anonymously in securities through proprietary networks. In some cases, customers would be able to initiate private negotiation sessions with merchants to establish the terms of trades.

There are many embodiments of dynamic trading systems and further subdivisions of the above categories, depending whether the trading system is specific to one AA or one integrating several AA's:

Single-Dealer Systems—Single-dealer systems would allow investors to execute transactions directly with one specific dealer, the preferred embodiment of the present invention.

Multi-Dealer Systems—Multi-dealer systems would provide merchants with consolidated orders from two or more investors, being members of two or more discrete M's and provide the merchant with the ability to execute from among multiple bids. Typically, multi-dealer systems would display to investors and merchants the best bid or ask price for a given lot of AR among all the prices posted by participating dealers. Participating dealers could potentially also act as principal in transactions.

Trading systems, in the context of the present invention, are categorized as primary markets (seller is the original merchant that generated the AR), secondary markets (seller has previously purchased the lot in a primary market), or distress markets (i.e. the lot has characteristics that indicate a greater potential for non-payment).

A primary market involves conducting a sale of the AR to a group of interested investors who accept an invitation to make bids to the merchant for the AR. The price of the AR is discounted from the perspective of the merchant in exchange for increased cash flow. Input into the sale process includes lots of AR for the trade. Information on each lot typically includes the vendor's name, the number of invoices in the account receivable, the face value of the invoices, and the payment due date and other information, as appropriate. The parameters of the trade preferably comprise the start time of the trading process, the end time, bid increment, the reserve price, and any characteristics specific to an individual lot.

The trading system component, under the control of the Exchange, is then used to conduct an online trade of the AR lot in the primary market. Bids are then placed by interested investors based on price or other non-price terms. An interface may be facilitated to detailed vendor information or analytic tools for investor due diligence. The ultimate successful bidder is finally determined and the winning bid information is typically displayed and stored. This includes the identity of the winning bidder (either a pseudonym or the real name) and the price. Since the merchant preferably establishes a reserve price, there is no requirement to accept the lowest bid. In a preferred embodiment, the trading process is conducted electronically via the Internet or a private network. In addition to the investors, parties having access to this trading system component preferably include collection agents and/or the merchants.

The primary market process is optional since another preferred embodiment requires the AA to play a primary market broker-like role by matching the AR with a prospective investor. The matched investor may then elect to conduct negotiations with the merchant over the terms of the purchase. If negotiations were successful then the investor would purchase the AR at the agreed-upon terms. Another embodiment would use an automated bid/offer Exchange where investors and merchants can arrive at an agreed transaction price as soon as the bid and offer prices meet.

The Exchange uses the trading subsystem or application mentioned earlier for primary markets on a secondary market for the AR to be traded between investors in a preferred embodiment. The underlying system is essentially the same as the primary market with the exception that title to the AR is being traded between two investors rather than a merchant and an investor. As with the primary market, responsibility for the collection of the debt remains with the AA at all times. There is still the same opportunity for new bidders to view the information that the original bidders did, with the same restrictions on merchant and client confidentiality.

The dynamic trading subsystem or application may also be used for facilitating a market for distressed AR.

Transfer Title is the process whereby the results of the dynamic trade are used to effect a legal transfer of title from the seller to the purchaser. The seller may be the merchant in a primary sale or an investor in a secondary or distress sale; the purchaser may be the investor purchasing in a primary, secondary or distress sale. In a preferred embodiment, a computer-based component under the control of the Exchange using one or more database(s) of titles of AR and title transfer history keeps track of the transactions as part of the process. The Exchange feeds input information concerning the lots of AR to be transferred (as mentioned above), invoice-level details, purchaser information, and the details of the deal (including the price, the effective date, the due date and other relevant information). The transfer of title is then facilitated; electronic title transfer documentation typically prepared; electronic signatures obtained from the investor and merchant and validated; and the transfer in ownership recorded. The output of the title transfer application includes the identities of the transferor and transferee, the details of the items traded, and the effective date. Interfaces are provided to the transferor and transferee.

This electronic title transfer system may also play a role in authenticating any AR before it is processed.

Transfer Funds from Investor to Merchant (or, Investor to Seller in a Secondary or Distressed Market) typically occurs concurrently with Transfer Title and is a three-step process where the M electronically collects funds from the buyer, deducts its processing fee, and then electronically forwards the remaining funds to the seller of a traded lot. This may be done also in advance or following title transfer.

This invention also includes the variation whereby a merchant or investor is paid by an AA prior to the AA receiving payment from the buyer who is indebted in respect of a specific AR. Effectively, the AA is providing interim credit to the merchant or investor. This would be governed by the agreement between the M and the merchant or investor.

In a preferred embodiment, funds transfer is effected by an electronic payment application or subsystem interfaced with the Exchange for the processing of all receipts and disbursements between merchants, investors and secondary sellers of AR. While methods of payments between the parties are typically done through automated debit or credit and specific payments online, investors may also make payment by check or other conventional means of payment.

Typical inputs to the fund transfer subsystem or application includes payment instructions, including the payee identification, the amount of payment, the effective date, and a transaction reference. The subsystem goes on to debit the investor's account and credit the seller's accounts on AR sale transactions. Where payments are pending, any settlement is monitored and failed settlements are highlighted. The subsystem then outputs payment and receipt information, including the payment amount, the payment date, the identities of the payor and payee, and a transaction reference. An interface is maintained by communication means to investors and sellers of AR, as appropriate.

The payment subsystem typically interfaces with an AR management subsystem or application for tracking of all AR being managed by the M. This process is described more fully below.

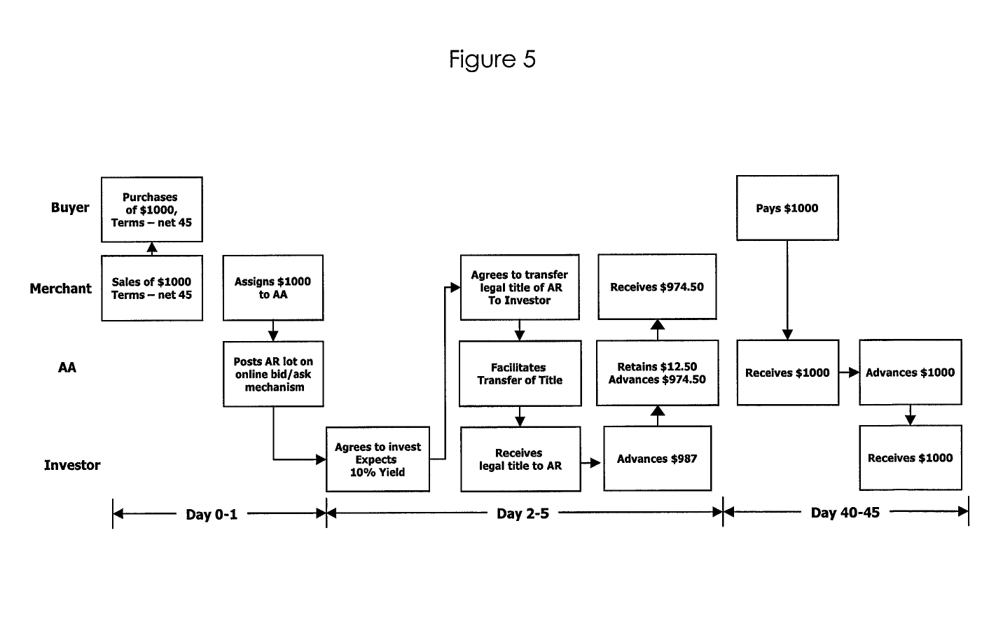

FIG. 5 illustrates the processes of offering AR for sale, their subsequent sale, the reciprocal transfer of title and transfer of funds triggered by that sale and the ultimate collection of moneys owed by the buyer in relation to the specific AR.

Collect AR is the process whereby the M conducts those activities necessary to track, collect, and process payments in respect of outstanding AR. In an ideal scenario, payments are simply received and processed by the M. In many instances however, the AA is required to proactively approach buyers in order to effect a timely payment.

Where the buyer fails to pay on time, there are several possible outcomes:

i) As part of the ARMMS enrolment process, the AA determines with the merchant how the latter wishes to proceed in such cases. For example, if the buyer is one of the merchant's more valuable ones, the merchant may wish to give the buyer a grace period, say of 5 days, before pursuing collection action. In other cases where the relationship between merchant and buyer is not as valued, the merchant may not particularly care what happens to the AR after it, the merchant, has received the advanced funds from the investor. In this case, collection efforts may proceed immediately. In all cases, the merchant's collection policy is available for inspection by investors before they bid on the merchant's AR package. In this case, the investor would rely upon the M's best efforts to collect the debt and await payment once terms had been arranged.

ii) If the failure to pay is due to the insolvency or protracted refusal to pay on behalf of the buyer, the credit enhancement facilitator pays out in this case. The investor would rely upon the AA dealing with the credit enhancement process and await payment at a later date.

iii) The investor may decide to dispose of the asset through the distressed AR market provided for by the ARMMS, selling the AR on to debt collection agencies or other entities willing to take the risk of non-payment in return for the possibility of enhanced yield.

iv) If the failure to pay is due to a dispute between the merchant and its buyer that occurs after the delivery of the merchant's product or service to the buyer, the merchant maintains funds in escrow with the AA and these funds are used to pay the obligation to the investor. In addition, since payment from a credit enhancement facilitator typically will cover only 90 percent of the notional amount of an AR's value, the merchant's funds in escrow will also be used to indemnify the current owner of the AR for the remaining percentage not covered by credit enhancement.

In any case, the risk of buyer non-payment or delayed payment is the quid pro quo for the investor accepting the possibility of yields higher than investments of comparable term. It is incumbent upon the investor to conduct his own due diligence, although the rigor of the due diligence would be tempered by the existence of credit enhancement. However, the credit risk would be based on the claims paying ability of the credit enhancement facilitator.

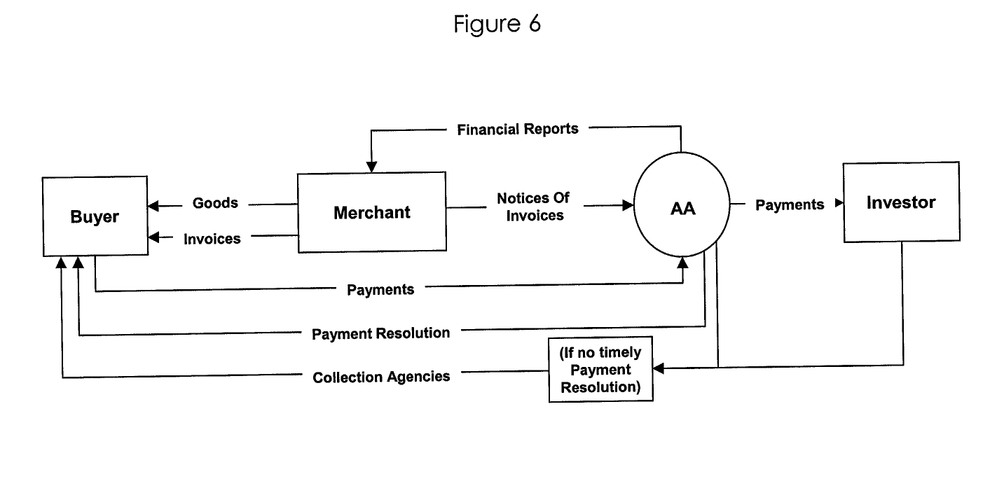

FIG. 6 shows the workflow of the AR management outsourcing process.

Interfacing with the electronic payment subsystem, the AR collection subsystem or application typically provides tools and reporting aids to proactively assist with the collections process. The subsystem takes as input information on AR (the merchant's identification, the buyer's identification, details of the invoice including the items purchased, the purchase order reference, the invoice amount, the shipping date, and the due date). Further inputs include payment details (the payor's identification, the transaction reference, the payment amount, and the date of receipt) and merchant-specific guidelines for collection. The functions of the subsystem includes tracking outstanding AR; matching receipts against receivables; providing AR reporting; and tracking payment history by merchants and buyers. Output of the subsystem includes comprehensive reporting of AR aging, expected receipts, delinquent accounts, and exception reports. Actual cash receipts are also reported.

Forward Payments to Investor is the daily process whereby each day's AR receipts are credited to the accounts of the ultimate owner of the AR.

Update/Maintain Files is a collection of processes oriented toward developing a timely and accurate repository of AR information that can be used by the M and the members of the ARMMS to make better decisions when trading AR. Information to manage comprises: payment experience by merchant; payment experience by buyer, disputed invoices, payment and default history, includes banking information for all Exchange members. This also includes the process of interfacing with merchants to update their own internal files.

### ADVANTAGES OF THE INVENTION

This invention presents numerous advantages to all parties who are active members of the Exchange, when compared to prior practices and available methods. Merchants benefit, Investors benefit, Collection Agents benefit, and Credit Enhancement Facilitators benefit.

Merchants—By selling title to AR for cash through the Exchange, merchants are able to significantly reduce the level of working capital required to run their businesses—essentially generating the same operating results with a lower investment required. This, algebraically, enhances their overall return on equity—a key measurement of any business' success.

This comes about because, although the merchant has relinquished title to an asset (i.e. the AR), it has received cash in return. This cash can be used to retire debt, pay a dividend to shareholders, or undertake projects that will grow the business.

An added benefit for merchants is that they no longer endure the liability of the client's non-payment for the goods delivered, since this liability has been transferred to the investor as the quid pro quo for accepting higher yield.

Further, there is a significant one-time financial saving to a merchant, which the process of financing and outsourcing AR management through an AA affords. This is because merchants who participate in the Exchange will reduce their days sales outstanding (DSO) from 45 days (assumed) on average to 5 days or less. For a typical company, a move to the Exchange can reduce outstanding receivables and the capital cost associated with them by 89%, or roughly 1.64% of sales, assuming a 15% cost of capital.

For a $100 million company, this amounts to freeing up almost $11 million in capital that carries an annual cost of $1.64 million (whether financed through the use of internal funds or through bank loans). This example assumes the merchant has an existing days sales outstanding figure of 45 days, that the AA can facilitate the sale of the merchants AR and simultaneous transfer of funds in 5 days and that the merchant currently finances its operations at a 15% weighted average cost of capital.

### EXAMPLE

Financing of AR under the existing financing structure:

($100M/(365/45))=$12.3M (amount of AR outstanding). The annual cost of financing $12.3M at 15% is ($12.3M×0.15)=$1.85M.

With an ARMMS, the days sales outstanding drop to 5 days (an estimate). Given this, the financing costs with the ARMMS are:

($100M/(365/5))=$1.37M (amount of AR outstanding). The annual cost of financing $1.37M at 15% is ($1.37M×0.15)=$0.21M.

With an ARMMS, there is a capital saving of $10.93 million ($12.3M-$1.37M) and an annual capital cost saving of $1.64 million ($1.85M-$0.21 M).

Beyond these financial benefits, merchants will benefit operationally from outsourcing their internal AR operations to the AA. The financial benefit to be derived from this transfer will depend largely on the merchant's internal efficiencies, but it could well represent a material financial benefit as well as a significant operational improvement.

Investors—Investors will benefit primarily through being able to efficiently invest in a financial asset class that has historically been impractical to invest in. AR generally represents an attractive asset class for investors in that they tend to have shorter terms and yet can generate attractive yields when compared to other investment alternatives. Historically, however, the complexities associated with investing in AR have made it uneconomic for institutional investors to participate in this asset class. Through this invention, however, AR can be traded efficiently and effectively in a liquid market by interested investors, likely of an institutional nature.

Collection Agents—Collection agents will benefit from the ability to bid on a broader range of AR than they would normally have access to absent this invention. They will also have access to a broad range of analytic tools and information that will enable them to price distressed AR assets fairly.

Credit Enhancement Entities—Credit enhancement entities—credit insurers, in a preferred embodiment—will benefit directly through the sale of incremental credit insurance policies that they otherwise would not have sold and will also benefit from the availability of a trading facility for distressed AR assets. The latter benefit will be realized when investors make claims against defaulted AR and the credit insurer becomes the resultant owner of an AR in default. Rather than collecting the defaulted AR itself, the insurer will be able to offer the AR on the Exchange and make it available to all Collection Agent members.

Credit Enhancement

In order to enhance the credit quality of the seller's AR assets, in one preferred embodiment a blanket credit insurance policy is carried with a trade credit insurance company with at least a double-A (i.e. investment grade) rating as determined by one or more of the large institutionally recognized credit rating agencies. Given a representative list of the merchants using an M's services and knowledge of the merchants' previous collective AR history, the insurance company can determine the amount of credit enhancement required to produce a credit quality comparable to, for example, that of a corporate bond of the same term. The premium for that credit insurance is added to the amount of the discount the investor applies when it buys AR through the Exchange. The merchant preferably shoulders both the expense of the investor's discount and the premium for the credit enhancement.

The credit enhancement (in this case, insurance) would provide a guarantee to potential buyers of the AR assets that their investment was insured to a minimum of a percentage of par value (typically 90%), should default or protracted refusal to pay occur. Provision of credit enhancement in such a manner would allow investors to potentially gain extra yield while still enjoying the safety of an investment grade credit rating. As well, such enhancement would increase the potential liquidity for all assets traded on the primary and secondary Exchanges since it would allow investment by investment funds whose by-laws or other internal or external regulatory stipulations prohibit investment into investment vehicles which are not rated double-A or higher, using generally accepted means of credit determination, for example, the services of credit information agencies such as Dun & Bradstreet Information Services, N.A. Inc., of Murray Hill, N.J, Standard & Poor's Corporation, of New York, N.Y., Moody's Investors Service, Inc. of New York, N.Y., Fitch Investors Service, Inc., of New York, N.Y., and Duff & Phelps Credit Rating Company, of Chicago, Ill. (“Duff & Phelps”).

To further enhance investor confidence, as a condition of transacting business with the AA, until empirical experience has shown that the buyers of a merchant are creditworthy, the merchant would be required to deposit funds in escrow with the AA which could be used to finance the credit insurance deductible (i.e. the 10% not covered by credit insurance in the example immediately above) should such a situation arise. Additionally, this escrow amount would provide recourse in the event of a merchant's attempt to sell fraudulent AR or a refusal to resolve a disputed invoice between it and its buyer.

Benefits of Credit Enhancement

The credit enhanced AR assets traded through the Exchange offer investors numerous benefits with regard to credit quality as follows.

High Credit Quality—Like other debt instruments, AR packages are evaluated and assigned a rating based on their ability to repay the investor as scheduled. But unlike most short-term assets, in a preferred embodiment of the invention, AR packages are credit-enhanced with internal structural features and/or external protections to ensure that obligations are met. Because of this, AR packages should be eligible for investment grade rating by the major credit rating agencies and should be received so by the investment community.

Reduced Event Risk—Since, in a preferred embodiment of the invention, the AR assets are secured by the merchant's clients ability to pay the merchant's invoices, as well as being secured by the credit enhancement vehicle, they offer significant protection against the risk of adverse developments against the merchant. This is especially so given that, in another preferred embodiment of the invention, the merchant outsources responsibility of collecting its AR to the AA.

A major concern investors have about other investment vehicles—commercial paper, for example—is that the rating agencies will downgrade them because of some disruptive event affecting the issuer. Such events might include mergers, takeovers and/or restructurings, which are often undertaken by corporate managers trying to boost shareholder value. In the extreme, such an event might include the issuer's bankruptcy. However, in a preferred embodiment of the invention, since title of the AR asset belongs to the investor and since the AA may maintain responsibility for collection of the AR, and because the credit enhancement vehicle may cover the buyers' inability to pay their invoices, any adverse event involving the merchant are substantially insulated.

The Modules and Subsystems

The Exchange consists of five major subsystems or applications (some are mentioned above), all of which are linked by the Exchange Manager (“EM”). Although these are indicated separately, this invention also includes variations where any two or more subsystems are part of the same subsystem. The principal systems are:

Exchange Auction (“EA”); (Note that an auction platform represents only one preferred embodiment of this invention. Any alternate dynamic trading solution could be implemented here in a different embodiment)

Exchange Title (“ET”);

Exchange Payment (“EP”);

Accounts Receivable Management (“ARM”); and,

Back Office Accounting (“BOA”).

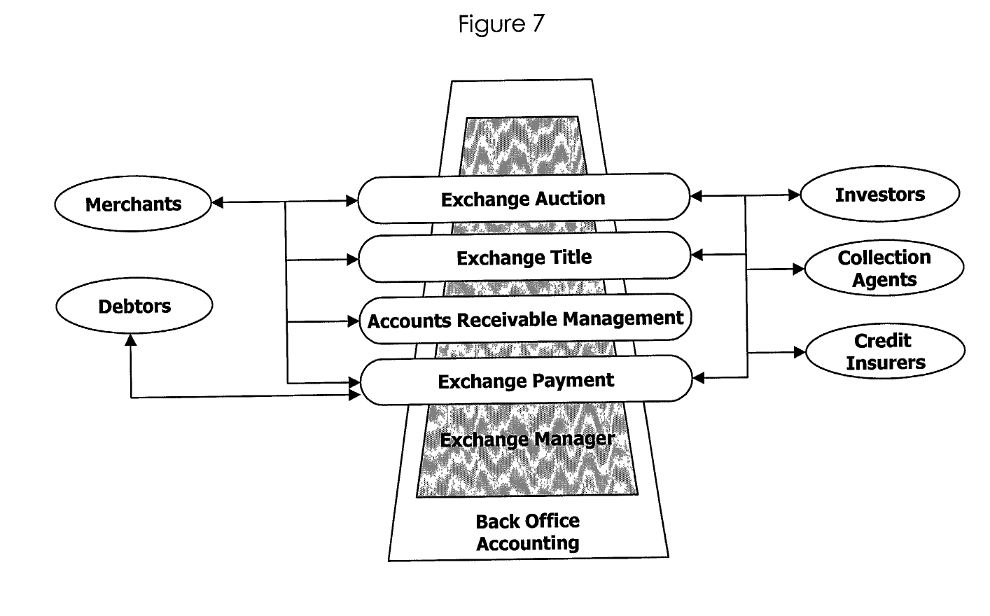

EA, ET, and EP are considered ‘user’ applications or subsystems as these have interfaces to the merchants, investors, collection agents, and buyers. In contrast, ARM and BOA are ‘internal’ applications or subsystems in that only the AA uses these. FIG. 7 shows a high-level application model of the invention in relation to the members of the ARMMS.

Each of the above subsystems or applications may be implemented as a subsystem of the Exchange or an independent application, which interfaces through the EM. There are commercially available versions of each of the five, which may be adapted or used without major change for the purpose of this process. Communication between the entities, whether parties or components of the ARMMS is preferably electronic in nature. A preferred embodiment uses the Internet as the networking medium; in another preferred embodiment a private network such as a wide area network or a virtual private network may be the communication means.

Exchange Manager

The EM is the core of the Exchange. It provides the functionality, workflow, and information management that drives all the other subsystems or applications within the Exchange.

The major functional modules within the EM are:

Enrolment

Accounts Receivable Posting

Trade Set Up

Trade Completion

Title Transfer

Funds Transfer

Daily Cash Sweep

Payment Analysis

Revenue Capture

Additionally, the EM houses and manages the Exchange Database. The functional modules of the EM are described in the following paragraphs.

Enrolment

The Enrolment module facilitates the enrolment of new members to the Exchange. The process varies depending on whether a new member is a merchant, investor, or collection agent. The module accepts inputs via a web-based interface and, once input is complete, forwards the prospective member's information to the AA, which takes the appropriate steps to validate and approve the enrolment. Once approved, the module establishes the member as an active participant in the Exchange, with appropriate electronic passwords to establish levels of security appropriate to the seniority of the merchant's employee using the system. For example, a clerk at the merchant's office may have permission to enter basic data about a lot of AR to be sold on the Exchange, but access to change banking and other payment details typically requires another level of security such as a password, which is available only to specific senior personnel on the merchant's staff.

The nature of information required for enrolment varies by type of member. Typical enrolment information would include

Merchants

Company Details

Authorized Contact Details and Levels of Security

AR Payment Experience

Preferred Collection Parameters

Banking Details

Electronic Signature

Investors/Collection Agents/Credit Insurers

Company Details

Authorized Contact Details

Banking Details

Electronic Signature

Accounts Receivable Posting

The Accounts Receivable Posting (ARP) module receives and validates AR lots from merchants wishing to sell their AR—a primary posting. It also receives AR lots from investors who have previously purchased AR lots and wish to trade them in the secondary market.

In the case of a primary posting, the ARP module receives an electronic file consisting of invoices that the merchant wants to sell as a lot. The ARP validates completeness and accuracy of the submitted file. The criteria to be determined by the ARP module include:

Client Identification

Items Purchased

Purchase Order Reference

Invoice Amount

Shipping Date

Invoice Date

Due Date

Then the ARP evaluates the merchant's status within the Exchange. For merchants who are relatively new to the Exchange, or where there have been prior issues, the module may seek human intervention to manually verify and approve the validity of the AR.

Where the merchant is not in a ‘probationary’ state, the ARP then approves the posting and proceeds to set up the AR in the ARM system. Concurrently, it initiates the trade set up process via an interface with EA.

For secondary or distress postings, if the AR has been traded once on the Exchange, the validation exercise may be bypassed, as may the process of setting up the AR in the ARM system. The module conducts rudimentary validation (e.g. to establish that the posting investor does in fact own title to the receivables being posted) and then forwards the lot to be set up as a trade on EA.

Trade Set Up

The Trade Set Up Module takes new AR postings from the ARM module and creates the necessary inputs to set up and initiate a new trade within EA. It does this by accessing the new AR posting as well as any specific trade parameters in the original merchant's enrolment profile. Concurrent with the preparation of AR for posting is the real-time generation of analytic tools from the Exchange database, which enable bidders to perform due diligence by examining various credit criteria relevant to a specific lot. These criteria may be obtained both from outside providers of credit information and internally from the payment analysis module of EM, described below. The trade setup module assigns each lot a unique serial number in order to track its progress through the various administrative processes within the ARMMS. Once setup is complete, control passes to EA to stage the trade process.

Trade Completion

Once the trade process is completed via the EA module, the EM notifies the successful bidder and the merchant. This process typically triggers the electronic transfer of title to the AR from the merchant to the investor (via ET) and electronic payment from the investor bidder to the merchanvinvestor (via EP). This process is described in greater detail below under Title Transfer.

Trade Completion, upon conclusion of a trade, initiates the appropriate processes to settle the resultant trade, described below under Title Transfer and Funds Transfer.

Title Transfer

Upon a successful bid by an investor for a specific AR lot and acceptance of such by the merchant, Title Transfer notifies the successful bidder and the merchant via electronic messaging. It subsequently determines the parameters for the initiated transfer of title and triggers the electronic transfer of title of the AR from the merchant to the investor via ET.

Transfer of title also prompts ET to trigger Title Transfer to enter the transaction in the Electronic Title Registry, a component of the Exchange Database. To facilitate transfer of title in the secondary and distressed markets at a later date, the EM also maintains an endorsement chain for each AR title, reflecting the transfer of rights and obligations between subsequent parties. In addition, the Electronic Title Registry also preferably maintains a timestamp of each endorsement in the endorsement chain so that a fully accurate record of each specific transfer of title is provided.

As is the case with the entire electronic messaging function of the EM, each electronic message generated by ET is entered in the full log of all Electronic Title registry transactions. These logs can be compared to the digitally signed acceptances by relevant parties maintained by the EM to prove transaction integrity and resolve any disputes.

Funds Transfer

Concurrent with the process of transferring title from the seller of the AR lot to the successful bidder is the transfer of funds for payment of such. The Funds Transfer module within the EM will determine the specific funds transfers that need to occur, calculate that appropriate amounts to transfer, access the Exchange Database to determine the appropriate payment instructions for each of the relevant counterparties, and then schedule and initiate the appropriate transfers through specific requests to the EP application.

The Funds Transfer module will also monitor the EP application for notification of settled transfers. This is critical inasmuch as the AA will generally require that funds be received and settled from an investor into the AA's omnibus account prior to deducting the AA's fee as well as initiating the transfer to the seller of the AR.

Daily Cash Sweep

The Daily Cash Sweep module will typically be run at the close of each business day to ensure that payments received (and cleared) from buyers in respect of related AR are credited appropriately to the accounts of the owners of the corresponding AR. The Cash Sweep module will access the Payments component of the Exchange Database to review all payments received from buyers that day and the AR lot that they are related to. For each payment that has cleared since the last cash sweep, the module will determine the rightful owner of the AR and will set up the appropriate payment debiting the AA's account and crediting the Investor's account.

Unless instructed otherwise, the module will generally be optimized so that no more than one payment is made to an Investor in any one day. To accomplish this, the module will accumulate all appropriate payments to make to each vendor and then initiate a single payment via the EP system.

Payment Analysis

Payment Analysis provides the necessary analysis and information management to assist investors and credit insurers in their ongoing assessment of the credit quality of any particular merchant's AR. For each AR item that is processed through the Exchange, the Payment Analysis module will track the timing of ultimate payment as well as the amount ultimately paid and any disputes, issues, or special actions taken by the AA that were related to its collection.

As well as capturing and managing this source payment data, the Payment Analysis module will provide analytic tools that will support Investors as they attempt to appropriately price a particular merchant's AR. Potential analyses would include:

Average Time From Invoice To Payment—Current And Historical

Frequency Of Disputed Invoices

Resolution Of Disputed Invoices

Frequency Distribution Of AR Payments Received (i.e. x% of payments received in 30 days, y% within 45 days, etc.)

Concentration Of AR Within A Buyer Group (i.e. 75% of AR generated by top n buyers)

Incidence Of Default/Credit Insurance claims

Using these analyses, an investor can arrive at an appropriate discount to apply when bidding for a particular merchant's AR.

Revenue Capture

The revenue capture module will monitor all transactions that are processed within the Exchange and will be responsible for calculating the appropriate fee to be deducted by the AA. There are a number of parameters that could determine the appropriate fee, including:

Merchant Specific Pricing

Volume Discounts

Primary Versus Secondary Trading

And Other Pricing Variations As Required By The Members.

Upon calculating the appropriate fee, the module will then prepare the appropriate accounting entries to be sent to the Back Office Accounting subsystem that will accrue the appropriate revenue for the AA.

It will also interface with the Funds Transfer module to initiate the appropriate cash payments, specifically, a transfer from the M's omnibus account to the M's house account and a transfer from the omnibus account to the AR seller's account. The first transfer will be the amount of the M's revenue on the trade while the second transfer will be the proceeds of an AR sale net of the AA's fee.

Exchange Auction

The Exchange Auction (“EA”) system provides the full functionality to establish and conduct a real time, online trade of AR lots. In a preferred embodiment, EA conducts the trading process in a secure online environment with various lots of AR from a number of merchants available to be bid upon by qualified investors. Prospective bidders may conduct due diligence on each lot by accessing analytical tools generated by data from the Exchange Database.

Merchants may be able to establish a reserve price for each lot to ensure that the lowest bid not be necessarily accepted. In addition, in order to further expedite cashflow, a merchant may establish a ceiling, at which price a bid automatically generates a sale, regardless of the time otherwise left in that lot's trading process. Merchants and investors may be able to see the current bid price on each lot and view the history of preceding bids.

Lots are typically up for bid for a specified term, for example, three days. At the end of that period, absent a prior sale of a specific lot, the merchant is contacted to solicit its instructions. These may include accepting the highest existing bid or taking the lot back in order to fund the relevant AR in an alternate manner. In any case, responsibility for administering the collection and payment for all of the merchant's AR—whether successfully traded or not—typically resides with the M in a preferred embodiment, consistent with one version of the conditions agreed by the merchant upon enrolment. In other embodiments, the M will not be administering the AR.

The process above describes a principal market, the initial sale of AR from the generating merchant to a qualified investor. In a preferred embodiment, in order to provide investors with the liquidity necessary to meet their portfolio management requirements, EA facilitates secondary markets, enabling investor-to-investor transactions. The process as described for the primary market generally pertains to the secondary market as well.

A tertiary preferred embodiment of EA is the facilitation of trades for distressed debt. In this application, lots which have exceeded their due date without full payment of the amount due by the merchant's buyers, and under the explicit direction of the investor or merchant, are offered for sale to credit agencies or other qualified parties willing to acquire AR assets at a discount, with the intent of collecting on the debt in full at a later date. The process for conducting the trade of distressed debt is substantively similar to the preceding two functions with the exception that conditions of sale or collection of the debt for each lot may be posted manually by the M on an as needed basis.

In a preferred embodiment of this invention, all three types of markets are present. Other embodiments involve subsets of the three markets of either one or two market types.

In one embodiment of the invention, bidders access EA, a secure application hosted within the Exchange's core environment, via an Internet browser and can remotely access all of the functions necessary to participate in a real time, online trade. This invention also includes the variation where a dedicated user application resides in the bidders' internal environments. The user application would communicate via one or more of various communication means with the Exchange, including the Internet, and direct telephone lines.

User functionality includes:

Viewing

AR lots listed for trade

Lot characteristics—number of invoices, face amount of invoices, payment due date

Type of market—primary, secondary, distress

Seller/originator characteristics, including the originator's AR payment experience, and any collection parameters unique to the AR originator

Trading details—start time, end time, presence of reserve bid, and any other unique characteristics

Current bids

Analytical tools to determine credit risk of each lot

Bidding

Enter bids

Bid history

Core functionality includes:

Setting Up The Trade

Receive trade parameters from the EM

Preparing the appropriate presentation so that relevant trade and originator details are accessible to users

Initiating a message to notify prospective bidders of a new AR lot

Conducting The Trade

Accepting bids

Tracking all bids

Preparing appropriate communications to ensure bidders (and sellers) are apprised of trade status

Messaging

Providing a forum for communicating both system generated as well as ad hoc messages to trade participants

Completing The Trade

Determining trade resolution (successful bid, reserve price exceeded, etc.)

Principal interfaces include:

Inputs

Trade and Lot information received from EM

Outputs

Trade results to EM: Successful bidder and final price

Dynamic Interfaces

To the Exchange Database (a sub-function of the ARM module) to access seller information and history, including collection parameters

In one embodiment of the invention, the functions of EA are enabled by commercially available electronic trading system software available from suppliers such as e-Speed Inc., of New York, N.Y. or e-PIT Systems, Inc., of San Francisco, Calif., customized for use by the AA. In an alternate embodiment, the functions of the EA module may be accessed through custom-written software.

Exchange Title

The Exchange Title (“ET”) system processes the electronic transfer of title for traded AR. It receives inputs from EM and uses the inputs to create, send, receive, and validate the appropriate instructions from both buyer and seller. Once appropriate messages have been exchanged and validated, the application records the fact that title has changed and also notifies EM of that development.

In a preferred embodiment, title of the AR is in encrypted electronic format and is facilitated by ET, which is an application for recording and transferring the legal rights and obligations of a specific lot of AR from a merchant (or investor, in the case of a secondary market) to an investor (or collection agency, in the case of a distressed AR market) via EA. According to this embodiment, the functionality of ET is provided within the context of the Exchange's secure environment.

Further to this embodiment, upon verification of the relevant parties' electronic signatures accepting the terms and conditions of the sale, ET electronically transfers title of the specific AR lot, as identified by its unique serial number. The transfer of title by ET prompts an automatic notification to the buying and selling parties via the electronic messaging function of the EM. This enables operational controls to prevent sending the electronic message to the wrong party, as well as providing internal auditing of all activities.

The principal inputs to ET are the details concerning title transfers resulting from successful trades:

Lots Of Accounts Receivable To Be Transferred

Vendor

Number of invoices

Face value of invoices

Payment Due date

Invoice level detail

Purchaser Information

Name

Contact information

Deal Details

Price

Effective date

Other Terms

Using these inputs, ET creates the necessary documents and effects the necessary communication and authentication with Exchange members to transfer title to the traded AR. It then sends confirmations to both buyer and seller and processes responses, matching them against predefined electronic signatures.

Operationally, the system may use electronic mail to notify members of a pending title transfer, whereby members are then routed to a secure web page that allows them to validate all the pending transfers that impact them.

Once all the documents are complete and validated, ET updates EM to that effect.

In one embodiment of the invention, the functions of ET are enabled by commercially available electronic title transfer software available from suppliers such as Bolero International Inc., of New York, N.Y. One preferred embodiment of the invention incorporates certain modifications to the commercially available ET software noted above that customize functionality to account for ET's unique aspects and requirements. In an alternate embodiment, the functions of the ET module may be accessed through custom-written software.

Exchange Payment

The Exchange Payment (“EP”) system effects the electronic transfer of funds between members. The principal events that typically drive payments are the sale of an AR lot and the receipt of moneys owed against a specific account receivable.

In the case of an AR lot sold, EP receives the necessary payment instructions from EM to generate the necessary transactions: debiting the buyers account for the purchase amount; crediting the AA's account with the transaction fee amount; and crediting the seller's account with the purchase amount less the AA's transaction fee. The Funds Transfer module within EM initiates each of these three transactions. EP, upon receiving the payment instructions, has access, via the Exchange Database, to the appropriate banking and authorization information to effect the necessary withdrawals and deposits.

In the case of remote debits, the AA may use the authorization for title transfer as the purchaser's authorization to execute a remote debit.

In the case of receipt of moneys owed against a specific receivable, EP receives the necessary payment instructions from EM's Daily Cash Sweep module and processes the transactions accordingly. In all cases, the payor is the AA and the payee the owner of the relevant AR.

The inputs from EM contain all of the information required to execute a payment: payor; payee; amount; and, effective date, banking information and other data as deemed necessary to effect funds transfer correctly. EP accesses the Exchange Database to obtain the appropriate banking information for all payors/payees.

EP also receives notification from financial institutions when payments are cleared. This allows EP to then signal that a payment is complete.

As an output, EP indicates to EM when payments have cleared and when payments fail.

Depending upon the embodiment of the invention, the EP application could either be hosted within the ARMMS' secure environment, or it could be hosted by a third party application service provider or financial institution, which would manage the various payments on the M's behalf. Funds may be transferred via the Automated Clearing House protocol, wire transfer or other electronic means, or by traditional paper-based check and clearing systems.

Accounts Receivable Management (ARM)

This is essentially a commercially available Accounts Receivable Management and Control package that helps the AA to manage its collections process. It receives new AR from the EM, it tracks payments received from buyers, and it generates a list of receipts for the EM's Daily Cash Sweep module.

The Accounts Receivable Management module will use a combination of the following sub-modules that address the business functions of the AA in an integrated manner:

Member Administration Modules integrate the different modules to automatically generate general ledger journal entries and allows originating merchants and subsequent investors to view their financial standing with the AA on an individual transaction or consolidated basis.

Reporting and General Ledger Modules allow the user to see the results of the previous modules, as user defined reports or accounting entries. The accounting entries can be exported to the Back Office Accounting system.

Risk Management Methods comprises interest rate and foreign exchange risk hedging as well as operational policies and procedures, which can be customized to an individual party's specific needs, as well as those of the AA.

Collection Management Modules assist with reporting and tracking of outstanding AR and provide analysis by merchant and buyer so as to enable a more effective collection process. This module will also manage the collection parameters that are in place for each merchant/buyer relationship. For example, the parameters might stipulate that a certain AR should be aggressively pursued from the due date onward, whereas another AR arising from a different merchant/buyer relationship should only be aggressively pursued after it becomes 30 days past due.

In addition to these functions, the Accounts Receivable Management module will have all the functions and features typically found in commercially available AR Management systems such as those available from as eCredit.com, Inc., of Dedham, Mass., and Ontario Systems Corp., of Muncie, Ind.

Back Office Accounting

The Back Office Accounting system is a critical, but straightforward component of the ARMMS. This system will interface with the EM and will support all of the M's internal accounting requirements. Of note, the system will maintain the M's general ledger accounts, produce regular financial reporting, and will maintain member accounts.

Its primary interface and source of input will be the EM as all activity affecting AA or member accounts will be sent to the Back Office Accounting system.

The functions of this accounting system are similar to those of any other financial trading environment and, accordingly, the system, in a preferred embodiment, would be implemented using commercially available accounting software or potentially through an external service bureau that provides such services to financial trading organizations such as Automatic Data Processing Inc. of Roseland, N.J.

Exchange Database

The Exchange Database, which is principally accessed and maintained by the EM, houses all of the information required to operate the ARMMS. It includes comprehensive data on each of the key types of Exchange members, all AR transactions processed through the Exchange, all AR processed within the ARMMS, as well as operating parameters that control the overall functioning of the ARMMS. The paragraphs below outline the key subject domains maintained within the database and for each key domain, the principal data elements. It should be noted that this is description is not meant to provide an exhaustive listing of all domains and data elements in the database, but rather to provide a sufficient overview so that an individual skilled in the art could reasonably construct such a database.

Merchants—name, address, contact names and trading authorizations, credit insurance coverage, AR offered for sale, AR trading history, AR payment history, dispute history, publicly available credit information, banking information, electronic signatures, collection policies and other information as appropriate to operate the ARMMS

Investors—name, address, contact names and trading authorizations, trading limits, banking information, AR owned, AR trading history—including profit and loss, electronic signatures, and other information as appropriate to operate the ARMMS.

Buyers—name, address, contact names, related merchants, payables outstanding, payment history, public and proprietary credit information, electronic payment instructions, and other information as appropriate to operate the ARMMS

Collection Agents—name, address, contact names and trading authorizations, trading limits, banking information, AR owned, AR trading history, electronic signatures, and other information as appropriate to operate the ARMMS.

Credit Insurers—name, address, contact names, coverage provided, claim policies, banking information, AR owned, AR trading history, electronic signatures, and other information as appropriate to operate the ARMMS.

Accounts Receivable—merchant name and address, buyer name and address, invoice date, invoice amount, invoice number, purchase order information, payment due date, payment terms and method, AR status (paid, outstanding, doubtful, etc), date traded, trade lot, AR owner, and other information as appropriate to operate the ARMMS.

AR Lots—lot identifier, constituent AR

Member Accounts—name and address, type of account (escrow, trading), balance, corresponding bank account, and other information as appropriate to operate the ARMMS.

AA Accounts—General Ledger accounts, Trading Accounts, status, balance, and other information as appropriate to operate the ARMMS.

Trades—Type of trade (primary, secondary, distress), AR lot, par amount, trade price, total trade value, trade date, settlement date, seller, purchaser, trade status (trade in process, trade pending, confirmed, settled), and other information as appropriate to operate the ARMMS.

System Architecture

The Accounts Receivable Market and Management System (“ARMMS”), is comprised of a variety of hardware and software elements. ARMMS' hardware elements may include one or more mainframe computers, terminals and workstations, personal computers, display devices such as monitors and printers, input devices such as keyboards and mice, communication devices such as modems, and the requisite cables and electrical connections.

In one embodiment, ARMMS is comprised, in part, of scalable servers, which are used to process most of the functions including client registration, market management, title transfer, payment, database maintenance, summarization, customer service systems, report production and various back office accounting and business management functions. In this embodiment, ARMMS utilizes a compatible, fault-tolerant operating system on the mainframe computer, and a database and file management system.

In another embodiment, ARMMS is also comprised of personal computers running on an operating system such as Windows NT RTM, available through Microsoft Corporation of Redmond, Wash., or a like product. The personal computers are linked together through a server-based network, thereby emulating the function of the mainframe computer embodiment described above. To facilitate the processing of information necessary to perform the operations described in greater detail below, a database management programming language is used along with a data base compiler.

In a preferred embodiment, outside parties accessing ARMMS do so by communicating electronically through various means such as the Internet, Virtual Private Network, via dedicated modem lines, or other like means of communication. A person of ordinary skill in the art would be able to properly assemble these hardware and software elements.

It will be appreciated that the above description relates to the preferred embodiments by way of example only. Many variations on the apparatus and method for delivering the invention will be obvious to those knowledgeable in the field, and such obvious variations are within the scope of the invention as described and claimed, whether or not expressly described.

All publications referred to in this paper are incorporated by reference in their entirety.

Trading and Processing of Commercial Accounts Receivable

Table of Contents

| | |
|---|---|
| FIELD OF THE INVENTION | 2 |
| BRIEF DESCRIPTION OF THE DRAWINGS | 2 |
| BACKGROUND OF THE INVENTION | 2 |
| SUMMARY OF THE INVENTION | 7 |
| OBJECTS OF THE INVENTION | 8 |
| Characteristics of Utility Specific to Investors' Interests | 9 |
| Characteristics of Utility Specific to Merchants' Interests | 10 |
| DETAILED DESCRIPTION OF THE INVENTION | 11 |
| Overview | 11 |
| The Parties | 13 |
| The Overall Process | 16 |
| Advantages of the Invention | 24 |
| Credit Enhancement | 26 |
| Benefits of Credit Enhancement | 27 |
| The Modules and Subsystems | 28 |
| Exchange Manager | 29 |
| Enrolment | 29 |
| Accounts Receivable Posting | 30 |
| Trade Set Up | 31 |
| Trade Completion | 32 |
| Title Transfer | 32 |
| Funds Transfer | 33 |
| Daily Cash Sweep | 33 |
| Payment Analysis | 34 |
| Revenue Capture | 34 |
| Exchange Auction | 35 |
| Exchange Title | 38 |
| Exchange Payment | 40 |
| Accounts Receivable Management (ARM) | 41 |
| Back Office Accounting | 42 |
| Exchange Database | 42 |

What is claimed is:

1. A method for facilitating a financial investment in at least one accounts receivable owned by a first person, comprising the steps performed by a systems manager using a computer-based system of:
(a) enrolling the at least one accounts receivable owned by the first person as a lot for a trade using a computer database;
(b) receiving at least one bid from at least one bidder for purchasing the lot; and,
(c) determining the result of the trade for the lot.
wherein each account receivable of the at least one accounts receivable is associated with a merchant's buyer and a merchant.

2. The method of claim 1, wherein the step of determining the most favorable bid comprises the steps of:
(a) advising the owner of the bids received;
(b) receiving from the owner a direction on the outcome result of the trade, the direction comprising one selected from the group consisting of:
acceptance of a successful bid received from a successful bidder in accordance with a pre-determined set of rules; and,
rejection of all the bids; and,
(c) notifying the at least one bidder of the result.

3. The method of claim 1, further comprising the step of requiring the merchant to enhance the credit quality of each of the at least one accounts receivable in order to bring the credit quality of the at least one accounts receivable up to investment grade.

4. The method of claim 3, wherein the merchant enhances the credit quality by procuring credit enhancement from a credit enhancer up to a pre-determined percentage of the value of the accounts receivable.

5. The method of claim 4, wherein credit enhancement is procured by obtaining credit insurance from an insurance provider possessing an investment grade credit rating.

6. The method of any of claims 3 to 5, wherein the at least one accounts receivable, having enhanced credit quality, is a financial instrument.

7. The method of claim 1, further comprising the step of providing information on the lot of at least one accounts receivable for examination by prospective bidders.

8. The method of claim 7, wherein the information is stored in a computer database and electronically accessible.

9. The method of claims 1 and 2, further comprising the step of transferring the title of the at least one accounts receivable from the first person to a successful bidder, if any, the successful bidder becoming the owner.

10. The method of claims 9, further comprising the step of facilitating the transfer of funds from the successful bidder, if any, to the first person.

11. The method of claim 1, further comprising the steps of:
(a) transferring the ownership of the at least one accounts receivable from the owner to a successful bidder, if any; and,
(b) facilitating the transfer of funds from the successful bidder, if any, to the owner.

12. The method of any of claims 1, 2, or 7 to 11, further comprising the step of managing the at least one accounts receivable in the lot on behalf of the owner.

13. The method of any of claims 3 to 6, further comprising the step of managing the at least one accounts receivable in the lot on behalf of the owner.

14. The method of any of claims 12 or 13, wherein the step of managing the at least one accounts receivable comprises:
(a) maintaining contact with the associated merchant's buyers in order to effect timely discharge of indebtedness associated with the at least one accounts receivable;
(b) receiving a payment from a merchant's buyer associated with the at least one accounts receivable;
(c) sending a receipt for the payment associated with the at least one accounts receivable to the merchant's buyer;
(d) forwarding the payment to the owner of the at least one accounts receivable;
(e) updating the computer database recording the relevant payment; and,
(f) recording all transactions with regard to the management of the at least one account receivable in the computer database.

15. The method of any of claims 1 and 2, wherein the trade is a primary market transaction concerning the sale of at least one accounts receivable from the first person, being the merchant of the at least one accounts receivable, to a successful bidder.

16. The method of any of claims 1 and 2, wherein the trade is a secondary market transaction concerning the sale of at least one accounts receivable from the first person, being the owner of the at least one accounts receivable, to a successful bidder.

17. The method of any of claims 1 and 2, wherein the trade is a distressed accounts receivable market transaction.

18. The method of any of claims 4 to 6, and 13, wherein the step of enrolling the at least one accounts receivable comprises receiving a fund from the first person, the fund to be held in escrow for settling future disputes concerning the at least one accounts receivable, such disputes comprising one or both of:
(a) the quality of goods or services rendered in relation to the at least one accounts receivable; and,
(b) provision of capital to fund the difference between the nominal value of the at least one accounts receivable and the payment received from the credit enhancement facilitator.

19. The method of any of claims 12 or 14, wherein upon a merchant's buyer not making a payment timeously to discharge the debt associated with a first accounts receivable being one of the at least one accounts receivable according to the terms of the at least one accounts receivable, the step of managing the at least one accounts receivable comprises consulting with owner of the at least one accounts receivable to determine the course of action, said course of action comprising one selected from the group consisting of:
(a) the owner waiting for the merchant's buyer to make the payment; and,
(b) the owner waiting for resolution of a dispute between the first owner and the merchant's buyer relating to the first accounts receivable before receiving the payment.

20. The method of claim 13, wherein upon a merchant's buyer not making a payment timeously to discharge the debt associated with a first accounts receivable being one of the at least one accounts receivable according to the terms of the at least one accounts receivable, the step of managing the at least one accounts receivable comprises consulting with owner of the at least one accounts receivable to determine the course of action, said course of action comprising one selected from the group consisting of:
(a) the owner waiting for the merchant's buyer to make the payment;
(b) the owner waiting for resolution of a dispute between the first owner and the merchant's buyer relating to the first accounts receivable before receiving the payment; and,
(c) the owner waiting for the provider of credit enhancement and the original owner to fulfill restitutional obligations.

21. The method of any of claims 19 or 20, wherein the trade is a distressed accounts receivable market transaction, and the group of courses of action further includes disposing of the first accounts receivable through the distressed accounts receivable market.

22. A system for facilitating a financial investment in at least one accounts receivable owned by a first person, operated by a systems manager, comprising electronic processors and electronic input-output devices which are adapted to communicate information using language, icons and graphical images, a computer database, and a communication network, wherein:
(a) the at least one accounts receivable owned by the first person is enrolled as a lot for the trade in the computer database;
(b) at least one bid from at least one bidder is received for purchasing the lot; and,
(c) the result of the trade for the lot is determined, wherein each account receivable of the at least one accounts receivable is associated with a merchant's buyer.

23. The system of claim 22, further comprising information on the lot of at least one accounts receivable stored in the computer database electronically for examination by wherein the information is electronically accessible.

24. The system of claim 22, further comprising a subsystem for transferring the title of the at least one accounts receivable from the first person to a successful bidder, the successful bidder becoming the owner.

25. The system of claim 23, further comprising a subsystem for facilitating the transfer of funds from a successful bidder to the first person.

26. The system of claim 22, further comprising a subsystem for managing the at least one accounts receivable in the lot on behalf of the owner, wherein the systems manager, assisted by an electronic processor of the system:
(a) maintains contact with the associated merchant's buyers in order to effect timely discharge of indebtedness associated with the at least one accounts receivable;
(b) receives a payment from a merchant's buyer associated with the at least one accounts receivable;
(c) sends a receipt for the payment associated with the at least one accounts receivable to the merchant's buyer;
(d) forwards the payment to the owner of the at least one accounts receivable;
(e) updates the computer database recording the payment; and,
(f) maintains the computer database recording all transactions with regard to the management of the at least one account receivable.

27. The system of claim 23, wherein the trade is a primary market transaction concerning the sale of at least one accounts receivable from the first person, being the originating merchant of the at least one accounts receivable, to a successful bidder.

28. The system of claim 23, wherein the trade is a secondary market transaction concerning the sale of at least one accounts receivable from the first person, being the owner of the at least one accounts receivable, to a successful bidder.

29. The system of claim 23, wherein the trade is a distressed accounts receivable market transaction.

30. A financial instrument for financial investment using a computer-based system comprising at least one accounts receivable owned by a first person, each account receivable of the at least one accounts receivable being associated with a merchant's buyer and a merchant, wherein a systems manager using the computer-based system:
(a) enrolls the at least one accounts receivable owned by the first person as a lot for the trade in a computer database;
(b) receives at least one bid from at least one bidder for purchasing the lot;
(c) determines the result of the trade for the lot; and
the merchant enhances the credit quality of each of the at least one accounts receivable for bringing the credit quality of the at least one accounts receivable up to investment grade.

31. The financial instrument of claim 30, wherein the merchant enhances the credit quality by procuring credit enhancement from a credit enhancer up to a pre-determined percentage of the value of the accounts receivable.

32. The financial instrument of claim 31, wherein credit enhancement is procured by obtaining credit insurance from an insurance provider possessing an investment grade credit rating.

33. The financial instrument of claim 30, wherein the systems manager determines the most favorable bid by performing the steps of:
(a) advising the owner concerning the bids received;
(b) receiving from the owner a direction on the outcome of the trade, the direction comprising one selected from the group consisting of:
acceptance of a successful bid received from a successful bidder in accordance with a pre-determined set of rules; and,
rejection of all the bids; and,
(c) notifying the at least one bidder of the direction.

34. The financial instrument of claim 30, wherein information on the lot of at least one accounts receivable is provided for examination by prospective bidders, the information being stored in a computer database and electronically accessible.

35. The financial instrument of claim 30, the systems manager using the computer-based system further:
(a) transfers the ownership of the at least one accounts receivable from the owner to a successful bidder, if any; and,
(b) facilitates the transfer of funds from the successful bidder, if any, to the owner.

36. The financial instrument of any of claims 30, the systems manager further manages the at least one accounts receivable in the lot on behalf of the owner.

37. The financial instrument of claim 37, wherein the systems manager manages the at least one accounts receivable by performing the steps of:
(a) maintaining contact with the associated merchant's buyers in order to effect timely discharge of indebtedness associated with the at least one accounts receivable;
(b) receiving a payment from a merchant's buyer associated with the at least one accounts receivable;
(c) sending a receipt for the payment associated with the at least one accounts receivable to the merchant's buyer;
(d) forwarding the payment to the owner of the at least one accounts receivable;
(e) updating the computer database recording the relevant payment; and,
(f) recording all transactions with regard to the management of the at least one account receivable in the computer database.

38. The financial instrument of claim 30, wherein the trade is one selected from the group consisting of:
a primary market transaction concerning the sale of at least one accounts receivable from the first person, being the merchant of the at least one accounts receivable, to a successful bidder;
a secondary market transaction concerning the sale of at least one accounts receivable from the first person, being the owner of the at least one accounts receivable, to a successful bidder; and,
a distressed accounts receivable market transaction.

39. The financial instrument of any of claims 36 or 37, wherein upon a merchant's buyer not making a payment timeously to discharge the debt associated with a first accounts receivable being one of the at least one accounts receivable according to the terms of the at least one accounts receivable, the step of managing the at least one accounts receivable comprises consulting with owner of the at least one accounts receivable to determine the course of action, said course of action comprising one selected from the group consisting of:
(a) the owner waiting for the merchant's buyer to make the payment; and,
(b) the owner waiting for resolution of a dispute between the first owner and the merchant's buyer relating to the first accounts receivable before receiving the payment;
(c) the owner waiting for the provider of credit enhancement and the original owner to fulfill restitutional obligations; and,
(d) where the trade is a distressed accounts receivable market transaction, the owner disposing of the first accounts receivable through the distressed accounts receivable market.
